(19) United States
(12) Patent Application Publication
(10) Pub. No.: US 2024/0385055 A1
(43) Pub. Date: Nov. 21, 2024

(54) OVEN APPLIANCES AND METHODS FOR ACCURATE COOK-TIME ESTIMATIONS

(71) Applicant: Haier US Appliance Solutions, Inc., Wilmington, DE (US)

(72) Inventors: Sean Simpson, Louisville, KY (US); James Lee Armstrong, Louisville, KY (US)

(21) Appl. No.: 18/317,653

(22) Filed: May 15, 2023

(51) Int. Cl. G01K 3/10; F24C 3/12; F24C 7/08; G01K 13/00

(52) U.S. Cl. CPC G01K 3/10; F24C 3/128; F24C 7/085; G01K 13/00

(57) ABSTRACT

An oven appliance may include a cabinet, a heat source, a temperature sensor, a user interface, and a controller. The cabinet may define a cooking chamber. The heat source may be disposed within the cooking chamber. The controller may be configured to direct a monitoring operation. The monitoring operation may include measuring a first temperature of a food item within the cooking chamber of the oven appliance, determining elapse of a detection interval instance, measuring a second temperature of the food item, calculating a temperature delta between the second temperature and the first temperature, determining the temperature delta is within a predetermined functional range, determining a time delta of time, estimating a remaining time of the food item based on the time delta in response to determining the temperature delta is within the predetermined functional range, and presenting the estimated remaining time at the user interface of the oven appliance.

### FIELD OF THE INVENTION

The present subject matter relates generally to oven or appliances for cooking food items, and more particularly to systems and methods for accurately estimating the remaining cook time of a food item.

### BACKGROUND OF THE INVENTION

Conventional residential and commercial oven appliances generally include a cabinet that defines a cooking chamber for receipt of food items for cooking. Heating elements are positioned within the cooking chamber to provide heat to food items located therein. The heating elements can include, for example, radiant heating elements, such as a bake heating assembly positioned at a bottom of the cooking chamber or a broil heating assembly positioned at a top of the cooking chamber.

Typically, food or utensils for cooking are placed on wire racks within the cooking chamber and above the bake heating assembly. When cooking certain food items, it may be important to check or monitor the temperature of the food item, e.g., in order to ensure the food item is adequately cooked. In the past, attempts have been made to estimate the remaining cook time for such food items based on the monitored temperature. However, when actually adopted in real-life environments, these past attempts have often struggled with accuracy or precision in estimating the actual remaining cook time (e.g., time until the food item reaches a target temperature). For example, existing systems and methods are easily disrupted by relocating a temperature sensor (e.g., on or within a food item) or otherwise having had a temperature sensor in a position that is not optimized for the food item. In such instances, estimations may vary wildly and lead to consumer frustration or disregard if the estimations cannot be relied upon.

As a result, improved systems and methods for estimating cook time would be useful. In particular, it may be advantageous to provide systems or methods capable of adapting to relocating a temperature sensor (e.g., relative to a food item), even during an active cooking operation.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, an oven appliance is provided. The oven appliance may include a cabinet, a heat source, a temperature sensor, a user interface, and a controller. The cabinet may define a cooking chamber. The heat source may be disposed within the cooking chamber. The temperature sensor may be in thermal communication with the cooking chamber to detect temperature at a food item therein. The user interface may include a display attached to the cabinet. The controller may be in operable communication with the temperature sensor. The controller may be configured to direct a monitoring operation. The monitoring operation may include measuring a first temperature of a food item within the cooking chamber of the oven appliance, determining elapse of a detection interval instance following detection of the first temperature, measuring a second temperature of the food item following measuring the first temperature, calculating a temperature delta between the second temperature and the first temperature, determining the temperature delta is within a predetermined functional range, determining a time delta of time between measuring the first temperature and measuring the second temperature, estimating a remaining time of the food item based on the time delta in response to determining the temperature delta is within the predetermined functional range, and presenting the estimated remaining time at the user interface of the oven appliance.

In another exemplary aspect of the present disclosure, a method of operating an oven appliance is provided. The method may include measuring a first temperature of a food item within a cooking chamber of the oven appliance and determining elapse of a detection interval instance following detection of the first temperature. The method may also include measuring a second temperature of the food item following measuring the first temperature and calculating a temperature delta between the second temperature and the first temperature. The method may further include determining the temperature delta is within a predetermined functional range and determining a time delta of time between measuring the first temperature and measuring the second temperature. The method may still further include estimating a remaining time of the food item based on the time delta in response to determining the temperature delta is within the predetermined functional range and presenting the estimated remaining time at a user interface of the oven appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of an oven appliance according to exemplary embodiments of the present disclosure.

FIG. 2 provides a cross-sectional view of the exemplary oven appliance of FIG. 1 taken along the line 2-2 of FIG. 1, wherein a temperature sensor is in a cavity-enclosed state.

FIG. 3 provides a schematic view of a sensor assembly according to exemplary embodiments of the present disclosure.

FIG. 4 provides a flow chart illustrating a method of operating an oven appliance according to more exemplary embodiments of the present disclosure.

FIG. 5 provides a flow chart illustrating a method of operating an oven appliance according to more exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

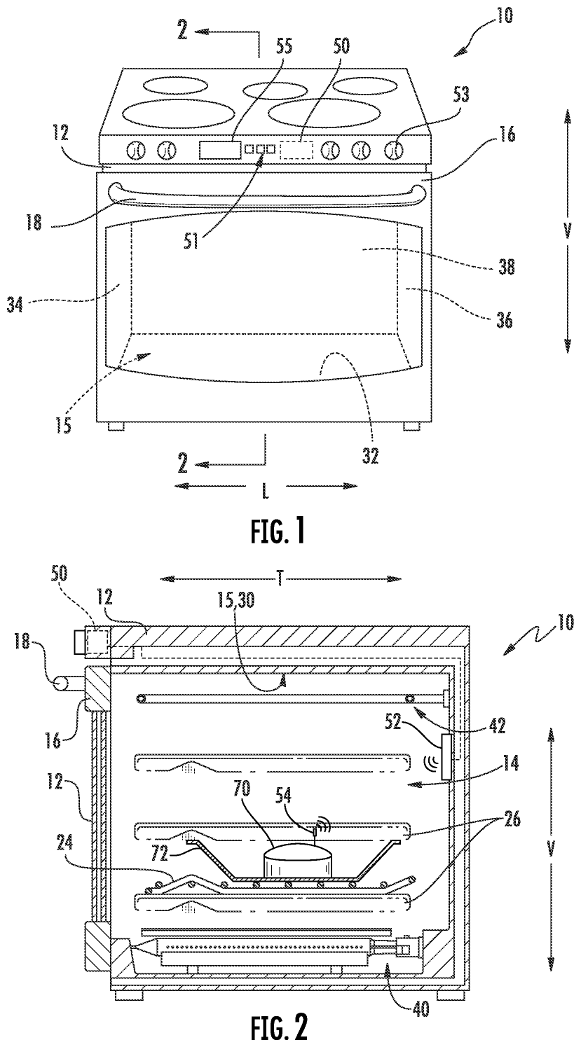

Turning now to the figures, FIG. 1 provides a front perspective view of an example oven appliance 10. FIG. 2 provides a cross-sectional view of oven appliance 10 taken along the line 2-2 of FIG. 1. Oven appliance 10 defines a vertical direction V, a lateral direction L, and a transverse direction T. The vertical direction V, lateral direction L, and transverse direction T are mutually perpendicular and form an orthogonal direction system. As will be understood, oven appliance 10 is provided by way of example only, and the present subject matter may be used in any suitable oven appliance 10. Thus, the present subject matter may be used with other oven or range appliance 10 configurations, e.g., that define multiple interior cavities for the receipt of food or having different configuration than what is shown in FIG. 2.

Oven appliance 10 includes an insulated cabinet 12 that defines an oven cavity, such as a cooking chamber 14. In this regard, as used herein, the terms “cabinet,” “housing,” and the like are generally intended to refer to an outer frame or support structure for appliance 10, (e.g., including any suitable number, type, and configuration of support structures formed from any suitable materials, such as a system of elongated support members, a plurality of interconnected panels, or some combination thereof.) It should be appreciated that cabinet 12 does not necessarily require an enclosure and may simply include open structure supporting various elements of appliance 10. By contrast, cabinet 12 may enclose some or all portions of an interior of cabinet 12. It should be appreciated that cabinet 12 may have any suitable size, shape, and configuration while remaining within the scope of the present subject matter.

Cooking chamber 14 may be defined by an interior surface 15 of cabinet 12. Cooking chamber 14 is configured for the receipt of one or more food items (e.g., food item 70) to be cooked. Oven appliance 10 includes a door 16 rotatably mounted to cabinet 12, e.g., with a hinge (not shown). A handle 18 is mounted to door 16 and assists a user with opening and closing door 16 in order to access opening 20 to cooking chamber 14. For example, a user can pull on handle 18 to open or close door 16 and access cooking chamber 14 through opening 20.

Oven appliance 10 can includes a seal (not shown) between door 16 and cabinet 12 that assist with maintaining heat and cooking fumes within cooking chamber 14 when door 16 is closed as shown in FIG. 2. Multiple parallel glass panes 22 may provide for viewing the contents of cooking chamber 14 when door 16 is closed and assist with insulating cooking chamber 14. In some embodiments, baking rack 24 is positioned in cooking chamber 14 for the receipt of one or more food items (e.g., food item 70) or utensils (e.g., utensil 72) containing food items. Baking rack 24 is slidably received onto embossed ribs 26 or sliding rails such that rack 24 may be conveniently moved into and out of cooking chamber 14 when door 16 is open.

As shown, various sidewalls define the cooking chamber 14. For example, cooking chamber 14 includes a top wall 30 and a bottom wall 32 which are spaced apart along the vertical direction V. Left sidewall 34 and right sidewall 36 (as defined according to a front view as shown in FIG. 1) extend between the top wall 30 and bottom wall 32, and are spaced apart along the lateral direction L. A rear wall 38 additionally extends between the top wall 30 and bottom wall 32 as well as between the left sidewall 34 and right sidewall 36, and is spaced apart from the door 16 along the transverse direction T. Cooking chamber 14 is thus defined between the top wall 30, bottom wall 32, left sidewall 34, right sidewall 36, and rear wall 38.

A heat source is generally mounted to cabinet 12 (e.g., within or otherwise in thermal communication with cooking chamber 14). In some embodiments, a gas fueled or electric bottom heating element 40 (e.g., a gas burner or a bake gas burner) is positioned in cabinet 12, e.g., at a bottom portion of cabinet 12. Bottom heating element 40 may be used to heat cooking chamber 14 for both cooking and cleaning of oven appliance 10. The size and heat output of bottom heating element 40 can be selected based on the e.g., the size of oven appliance 10.

In optional embodiments, a top heating element 42 is positioned in cooking chamber 14 of cabinet 12, e.g., at a top portion of cabinet 12. Top heating element 42 is used to heat cooking chamber 14 for both cooking/broiling and cleaning of oven appliance 10. Like bottom heating element 40, the size and heat output of top heating element 42 can be selected based on the e.g., the size of oven appliance 10. In the example embodiment shown in FIG. 2, top heating element 42 is shown as an electric resistance heating element. However, in alternative embodiments, a gas, microwave, halogen, or any other suitable heating element may be used instead of electric resistance heating element 42.

Oven appliance 10 may further include a controller 50, e.g., configured to control one or more operations of the oven appliance 10. For example, controller 50 may control at least one operation of oven appliance 10 that includes one or more of heating elements 40 and 42. Controller 50 may be in communication (via for example a suitable wired or wireless connection) with the heating element 40, heating element 42, user interface panel 51, temperature sensor 54 (e.g., either directly or indirectly, such as via an signal reader 52), and other suitable components of the oven appliance 10, as discussed herein. In general, controller 50 may be operable to configure the oven appliance 10 (and various components thereof) for cooking. Such configuration may be based, for instance, on a plurality of cooking factors of a selected operating cycle or mode, e.g., as selected at user interface panel 51.

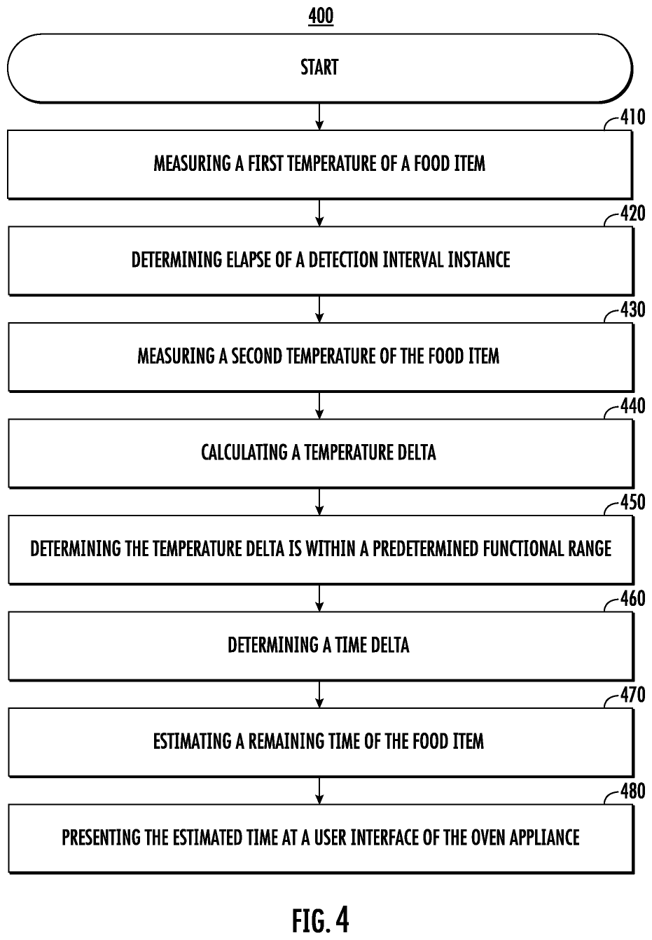

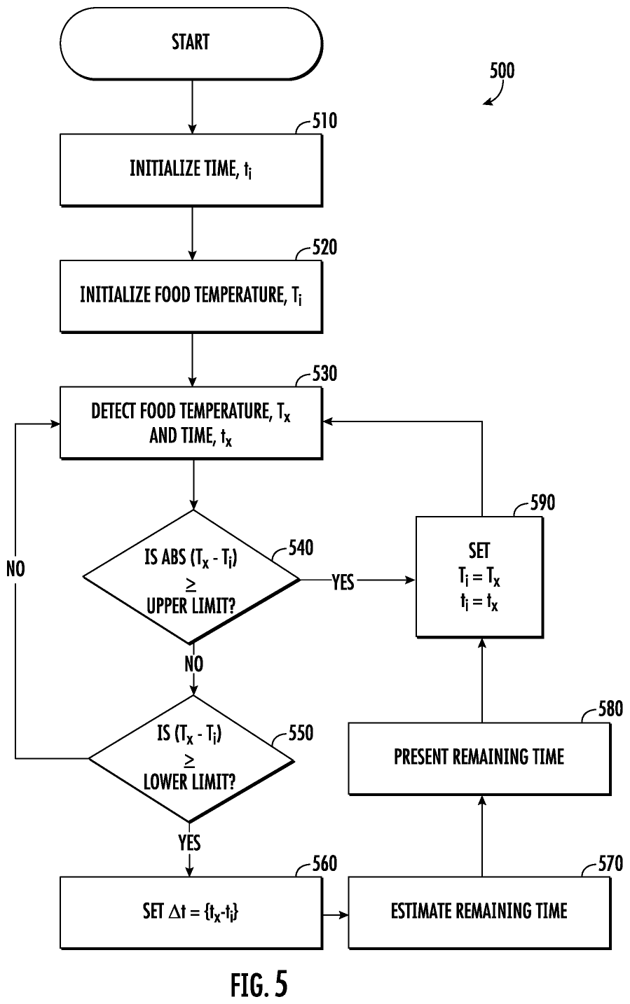

By way of example, controller 50 may include one or more memory devices and one or more microprocessors, such as general or special purpose microprocessors operable to execute programming instructions or micro-control code associated with an operating cycle. The memory device (i.e., memory) may represent random access memory such as DRAM, or read only memory such as ROM or FLASH. In one embodiment, the processor executes programming instructions stored in memory. The memory may be a separate component from the processor or may be included onboard within the processor. The memory can store information accessible to processing device, including instructions that can be executed by processing device. Optionally, the instructions can be software or any set of instructions that, when executed by the processing device, cause the processing device to perform operations. For certain embodiments, the instructions include a software package configured to operate appliance 10 and initiate one or more predetermined sequences (e.g., monitoring operations). For example, the instructions may include a software package configured to execute one or more of the example methods 400 or 500 described below with reference to FIGS. 4 and 5.

Controller 50 may be positioned in a variety of locations throughout oven appliance 10. As illustrated, controller 50 may be located within a user interface panel 51 of oven appliance 10 as shown in FIGS. 1 and 2. In some such embodiments, input/output (“I/O”) signals may be routed between controller 50 and various operational components of oven appliance 10, such as heating element 40, heating element 42, temperature sensor 54, controls 53, display component 55, sensors, alarms, or other components as may be provided. For instance, signals may be directed along one or more wiring harnesses that may be routed through cabinet 12.

In some embodiments, user interface panel 51 includes input components or controls 53, such as one or more of a variety of electrical, mechanical or electro-mechanical input devices. Controls 53 may include rotary dials, push buttons, and touch pads. Controller 50 is in communication with user interface panel 51 and controls 53 through which a user may select various operational features and modes and monitor progress of oven appliance 10. In additional or alternative embodiments, user interface panel 51 includes a display component 55, such as a digital or analog display in communication with controller 50 and configured to provide operational feedback to a user. In certain embodiments, user interface panel 51 represents a general purpose I/O (“GPIO”) device or functional block.

In some embodiments, a temperature sensor 54 is provided (e.g., in wired or wireless communication with controller 50) to detect the temperature of one or more food items 70 within cooking chamber 14. Generally, temperature sensor 54 is in thermal communication with cooking chamber 14 (e.g., disposed outside or, alternatively, within cooking chamber 14 to detect a temperature of an item or environment within cooking chamber). Temperature sensor 54 may include or be provided as any suitable sensor wired or wireless for detecting food temperatures. For instance, temperature sensor 54 may include temperature-detection circuit having a thermistor, a thermocouple, a bimetal thermostat, a resistive temperature device (RTD), or any other device housed within a sensor body. Moreover, one or more conductive probes, rods, or shafts may extend from the temperature-detection circuit (e.g., to be received by a liquid, food item 70, or utensil 72). As would be understood, the temperature sensor 54 (or temperature-detection circuit thereof) may be provided in wired communication with controller 50 via one or more conductive wires or busses. As would further be understood, the temperature sensor 54 (or temperature-detection circuit thereof) may be provided in wireless communication via one or more wireless modules (e.g., included with controller 50 or sensor 74) configured to communicate with one or more nodes over a wireless network (such as a Bluetooth communication network), a wireless local area network (WLAN), a point-to point communication networks (such as radio frequency identification networks, near field communications networks, etc.), or a combination of two or more of the above communications networks.

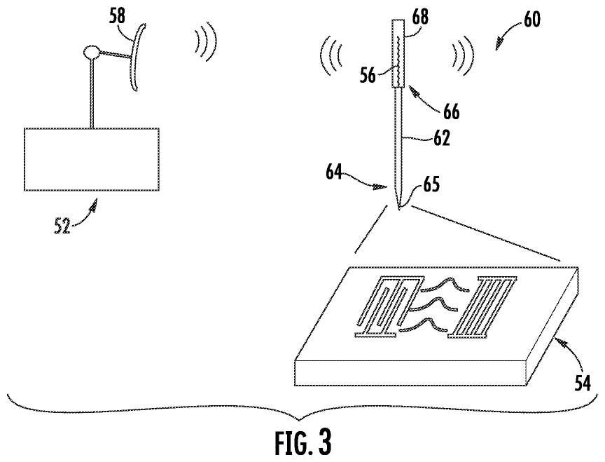

In the illustrated embodiments of, for example, FIG. 3, temperature sensor 54 is provided as part of a multi-element sensor assembly. In some such embodiments, a signal reader 52 (e.g., acoustic wave reader) is provided to communicate with a discrete temperature sensor 54 (e.g., surface acoustic wave (SAW) temperature sensor) spaced apart from the signal reader 52. For instance, the signal reader 52 may be disposed within the cabinet 12 in communication with cooking chamber 14. During use, signal reader 52 may monitor cooking chamber 14. During use, at least a portion of signal reader 52 may be disposed within, or extend into, cooking chamber 14. The signal reader 52 may be in communication with the controller 50, e.g., via one or more conductive wires or busses electrically coupling signal reader 52 to controller 50. Temperature sensor 54 may be configured to detect changes in temperature, e.g., through strain deformation induced by heat at temperature sensor 54. Temperature sensor 54 is generally configured for operable communication with signal reader 52. For instance, a pair of coupled antennas 56, 58 may be provided. A sensor antenna 56 may be electrically coupled to temperature sensor 54. A reader antenna 58 may be electrically coupled to signal reader 52. Together or in isolation, sensor antenna 56 and reader antenna 58 may permit or provide communication, e.g., wireless communication, between temperature sensor 54 and signal reader 52. Alternatively, however, SAW

During operation, temperature sensor 54 may selectively receive or transmit signals from signal reader 52. For instance, an interrogation signal, e.g., electromagnetic pulse, may be transmitted from signal reader 52 at reader antenna 58. The interrogation signal may be received at sensor antenna 56 and converted into a surface acoustic wave on temperature sensor 54. Characteristics of the surface acoustic wave (e.g., frequency) may be varied according to the temperature detected at the temperature sensor 54. A condition signal, e.g., a temperature signal, may be transmitted from the temperature sensor 54 in response to the received interrogation signal. The condition signal may be received at signal reader 52. The condition signal may reflect the characteristics of the surface acoustic wave that was induced by the interrogation signal. Moreover, the condition signal may reflect changes or conditions at the temperature sensor 54. Once received, the condition signal may be interpreted as temperature data (e.g., sensed values) or transmitted to controller 50.

Some embodiments of temperature sensor 54 are housed within a portable food probe 60. For instance, temperature sensor 54 may be embedded within one end portion 64 of food probe 60. Generally, food probe 60 may be provided as a narrow conductive shaft 62 having a sharpened tip 65 extending from the end portion 64 for insertion into a liquid or food item 70. A handle 68 may be attached to food probe 60, e.g., at an opposite end portion 66. In some such embodiments, sensor antenna 56 is housed within handle 68. Food probe 60 may extend into handle 68 and electrically couple temperature sensor 54 to sensor antenna 56. Additionally or alternatively, a conductive wire or bus may electrically couple temperature sensor 54 to sensor antenna 56.

Although FIG. 3 illustrates temperature sensor 54 within food probe 60, additional or alternative embodiments of temperature sensor 54 may directly engage a utensil 72. For instance, temperature sensor 54 may be disposed on a utensil 72 in conductive thermal engagement therewith. When utensil 72 is placed within cooking chamber 14, heat may be conducted from a portion (e.g., a wall) of utensil 72 to temperature sensor 54. Some embodiments may include a clip, mated groove, or another mechanical attachment mechanism to selectively attach temperature sensor 54 to utensil 72. Alternatively, temperature sensor 54 may be embedded within a utensil 72, e.g., in a wall thereof. Moreover, although illustrated as part of a wireless multi-element assembly in FIGS. 2 and 3, temperature sensor 54 may include or be provided as a wired temperature sensor (e.g., having a wire extending to cabinet 12 from a discrete probe element), as would be understood.

Turning now to FIGS. 4 and 5, the present disclosure may further be directed to methods (e.g., method 400 or 500) of operating an oven appliance, such as appliance 10. In exemplary embodiments, the controller 50 may be operable to perform various steps of a method in accordance with the present disclosure.

The methods (e.g., 400 or 500) may occur as, or as part of, a cooking operation of oven appliance 10. In particular, the methods (e.g., 400 or 500) disclosed herein may advantageously estimate and account for food item cooking times. Additionally or alternatively, such methods may be capable of adapting to relocating a temperature sensor (e.g., relative to a food item), even during an active cooking operation.

It is noted that the order of steps within methods 400 and 500 are for illustrative purposes. Moreover, none of the methods 400 and 500 are mutually exclusive. In other words, methods within the present disclosure may include one or more of methods 400 and 500. All may be adopted or characterized as being fulfilled in a common operation. Except as otherwise indicated, one or more steps in the below method 400 or 500 may be changed, rearranged, performed in a different order, or otherwise modified without deviating from the scope of the present disclosure.

Turning especially to FIG. 4, at 410, the method 400 includes measuring a first temperature of a food item. For instance, the first temperature may be measured at a temperature sensor disposed within the cooking chamber (e.g., as described above). In some such embodiments, at least a portion of the temperature sensor is in thermal communication with the food item (e.g., conductive thermal communication via a probe fixed to the temperature sensor). As would be understood, one or more signals may be received from the temperature sensor and may be used to calculate a corresponding first temperature value for the food item.

At 420, the method 400 includes determining elapse of a detection interval instance (e.g., following 410). For instance, simultaneously to, with, or as part of 410, a timer may begin or otherwise record (e.g., temporarily) an initial or first time corresponding to measurement of the first temperature. Subsequently, the detection interval instance may be determined to expire (e.g., at a subsequent or second time). The duration of the detection interval may be a fixed time period or, alternatively, a variable time period that is selectively set (e.g., based on or according to one or more input variables).

At 430, the method 400 includes measuring a second temperature of the food item following 410. For instance, 430 may following or be in response to 420. The second temperature may be measured at the temperature sensor disposed within the cooking chamber (e.g., as described above). In other words, the second temperature may be measured from the same temperature sensor as the first temperature, but at a later point in time. As noted above, at least a portion of the temperature sensor may be in thermal communication with the food item (e.g., conductive thermal communication via a probe fixed to the temperature sensor). As would be understood, one or more signals may be received from the temperature sensor and may be used to calculate a corresponding second temperature value for the food item. Additionally or alternatively, a second time (e.g., point in time) may be measured or recorded (e.g., temporarily) at the moment of measuring the second temperature.

At 440, the method 400 includes calculating a temperature delta. In particular, a delta or difference between the second temperature and the first temperature maybe measured. Generally, 440 follows 430. In some embodiments, 440 is in response to 430.

At 450, the method 400 includes determining the temperature delta is within a predetermined functional range. Thus, it may generally be determined that the second temperature delta is at least within a set band or range of the first temperature. In some embodiments, 450 includes determining an absolute value of the temperature delta, then comparing the absolute value to an upper delta limit. The absolute value of the temperature delta may be required to be less than the upper temperature limit. Thus, 450 may include determining an absolute value of the temperature delta is less than an upper delta limit. Optionally, upper delta limit may be greater than or equal to 20° Fahrenheit (F).

In additional or alternative embodiments, 450 includes determining the temperature delta is greater than or a lower delta limit. For instance, 450 may include comparing the temperature delta to the lower delta limit. In some such embodiments, comparison of the temperature delta to the lower delta limit follows or is in response to determining the absolute value of the temperature delta is less than the upper delta limit. Optionally, the lower delta limit may be less than or equal to 10° F.

At 460, the method 400 includes determining a time delta. Specifically, 460 includes determining a delta or difference of time between measuring the first temperature and measuring the second temperature. In other words, the time period or duration between the first time and the second time may be calculated. This time period may be adopted or recorded (e.g., temporarily) as the time delta.

At 470, the method 400 includes estimating a remaining time of the food item. Specifically, the remaining food time (e.g., time until the food item reaches a desired cooking state or target temperature) may be estimated based on the time delta of 460. In certain embodiments, a predetermined formula for estimating remaining time may be provided. Such a formula may be, for example, empirically derived based on the model of the oven appliance (e.g., using a prototypical unit of the same model line as the oven appliance). Thus, along with one or more derived constants, the formula may utilize time delta or the second temperature as one or more variables. As a strictly non-limiting example, a predetermined formula may be provided as:

$${t}_{R} = ( {T}_{T} - {T}_{x} ) / ( {C}_{1} + {C}_{2} * {T}_{x} + {C}_{3} * Δ {t}^{- 1} ) ,$$

wherein:
t_{R}=estimated remaining time,
T_{T}=target temperature,
Tₓ=second temperature,
C₁, C₂, C₃=empirically derived constants, and
Δt=time delta of second time minus first time.

Generally, 470 follows 450. In some embodiments, 470 is in response to determining the temperature delta is within the predetermined functional range at 450.

At 480, the method 400 includes presenting the estimated remaining time at a user interface of the oven appliance (e.g., automatically or in response to 470). In some such embodiments, the presentation is provided as a countdown or “time to completion.” In other embodiments, the presentation is provided as a future clock time or “time at which the food item is ready.” Nonetheless, any suitable image or representation may be provided. For instance, at the user interface of the oven appliance, the estimated remaining may be shown, projected, or otherwise displayed (e.g., as would be understood). Thus, a user may have a clear view or understanding of the anticipated time needed in order for the food item to reach the desired state or target temperature.

It is noted that the method 400 may continue to update the estimate time automatically as the food item continues to cook (e.g., to the target temperature). Such updates may occur automatically (e.g., without direct user input). Moreover, and as would be understood in light of the present disclosure, various steps may be repeated to determine if new or updated estimated times will be presented.

As an example, following 470, the method 400 may detect conditions that do not affect the estimated remaining times. For instance, method 400 may further include determining elapse of a second detection interval instance (e.g., equal to the time period of the first detection interval) following detection of the second temperature. Subsequently, the method 400 may again measure temperature. Thus, the method 400 may include measuring a third temperature of the food item (e.g., at the same temperature sensor) in response to elapse of the second detection interval instance. Moreover, method 400 may include calculating a second temperature delta between the third temperature and the second temperature. In contrast to the first temperature delta of 450, the second temperature delta may be outside of the predetermined functional range. As an example, the method 400 may include determining an absolute value of the second temperature delta is greater than the upper delta limit. As an additional or alternative example, the method 400 may include determining the second temperature delta is less than a lower delta limit. In response to determining the second temperature delta is outside of the predetermined functional range, the method 400 may provide for maintaining the estimated remaining time. Thus, the estimate from 460 may be unaffected (e.g., such that the proceeding countdown or future clock time is not altered by the calculation of a second temperature delta).

As an additional or alternative example, following 470, the method 400 may detect conditions that lead to updated estimated times. For instance, method 400 may further include determining elapse of a third detection interval instance (e.g., equal to the time period of the first detection interval) following detection of the third temperature. Subsequently, the method 400 may again measure temperature. Thus, the method 400 may include measuring a fourth temperature of the food item (e.g., at the same temperature sensor) in response to elapse of the third detection interval instance. Moreover, method 400 may include calculating a third temperature delta between the fourth temperature and the third temperature. Similar to the first temperature delta of 450, the third temperature delta may be determined to be within the predetermined functional range. Following or in response to such a determination, the method 400 may include determining a third time delta of time between measuring the third temperature and measuring the fourth temperature. In turn, and response to determining the third temperature delta is within the predetermined functional range, the method 400 may include updating the estimated remaining time of the food item based on the third time delta. As would be understood, the formula used for the estimation may be the same as 470, though the variables may be updated as or in light of the fourth temperature (e.g., in place of the second temperature) or the third time delta (e.g., in place of the first time delta). Once determined, the updated estimated time may be presented at the user interface of the oven appliance.

Turning now to FIG. 5, at 510, the method 500 includes initializing a timer with an initial (e.g., first) time (tᵢ). In other words, during or as part of a cooking operation in which a food item is received within the cooking chamber, a first time (i.e., point in time) may be noted or recorded (e.g., temporarily) as the initial time.

At 520, the method 500 includes measuring an initial (e.g., first) temperature (Tᵢ) of a food item. For instance, the initial temperature may be measured at a temperature sensor disposed within the cooking chamber (e.g., as described above). In some such embodiments, at least a portion of the temperature sensor is in thermal communication with the food item (e.g., conductive thermal communication via a probe fixed to the temperature sensor). As would be understood, one or more signals may be received from the temperature sensor and may be used to calculate a corresponding temperature value for the food item. Such a corresponding temperature may be recorded (e.g., temporarily) as the initial temperature (Tᵢ).

Optionally, 520 occurs at the same time as 510 (e.g., simultaneously therewith). Thus, as the initial temperature (Tᵢ) is measured, the initial time (tᵢ) may also be recorded.

At 530, the method 500 includes measuring a subsequent (e.g., second) temperature (Tₓ) at a subsequent (e.g., second) time (tₓ) following 520.

The subsequent temperature may be measured at the temperature sensor disposed within the cooking chamber (e.g., as described above). In other words, the subsequent temperature may be measured from the same temperature sensor as the initial temperature, but at a later point in time. As noted above, at least a portion of the temperature sensor may be in thermal communication with the food item (e.g., conductive thermal communication via a probe fixed to the temperature sensor). As would be understood, one or more signals may be received from the temperature sensor and may be used to calculate a corresponding subsequent temperature value for the food item. Such a corresponding temperature may be recorded (e.g., temporarily) as the initial temperature (Tₓ).

In some embodiments, 520 follows or is in response to determining elapse of a detection interval instance (e.g., following 510 or 520). For instance, simultaneously to, with, or as part of 510, the timer may begin to countdown to expiration of a set detection interval. Once the interval expires, 520 may be prompted. Additionally or alternatively, countdown of a new instance of the detection interval may begin (e.g., to prompt detection or measurement of a new temperature of the food item).

At 540, the method 500 includes evaluating an absolute temperature delta between the subsequent temperature (Tₓ) and the initial temperature (Tᵢ) in view of an upper limit (e.g., upper delta limit). In particular, the absolute temperature delta may be compared to the upper limit. If the absolute temperature delta is greater than or equal to the upper limit, the method 500 may proceed directly to 590. By contrast, if the absolute temperature delta is less than the upper limit, the method 500 may proceed to 550. Optionally, upper limit may be greater than or equal to 20° F.

At 550, the method 500 includes evaluating a temperature delta between the subsequent temperature (Tₓ) and the initial temperature (Tᵢ) in view of a lower limit (e.g., lower delta limit) (e.g., subsequent or in response to 540). In particular, the temperature delta may be compared to the lower limit. If the temperature delta is not greater than or equal to the lower limit, the method 500 may return to 530 (e.g., to detect and record a new subsequent temperature and subsequent time as Tₓand tₓ, respectively, in place of the previously recorded values—i.e., Tₓ₁ and tₓ₁ replacing Tₓ₀ and tₓ₀). By contrast, if the absolute temperature delta is greater than or equal to the lower limit, the method 500 may proceed to 560. Optionally, the lower limit may be less than or equal to 10° F.

At 560, the method 500 includes setting a time delta. In particular, the time delta is calculated as the difference between the subsequent time (tₓ) and the initial time (tᵢ). In other words, the time period or duration between the current initial time and subsequent time may be calculated. This time period may be adopted or recorded (e.g., temporarily) as the time delta (Δt).

At 570, the method 500 includes estimating a remaining time of the food item. Specifically, the remaining food time (e.g., time until the food item reaches a desired cooking state or target temperature) may be estimated based on Δt. In certain embodiments, a predetermined formula for estimating remaining time may be provided. Such a formula may be, for example, empirically derived based on the model of the oven appliance (e.g., using a prototypical unit of the same model line as the oven appliance). Thus, along with one or more derived constants, the formula may utilize time delta or the second temperature as one or more variables. As a strictly non-limiting example, a predetermined formula may be provided as:

$${t}_{R} = ( {T}_{T} - {T}_{x} ) / ( {C}_{1} + {C}_{2} * {T}_{x} + {C}_{3} * Δ {t}^{- 1} ) ,$$

wherein:
t_{R}=estimated remaining time,
T_{T}=target temperature,
Tₓ=current subsequent temperature,
C₁, C₂, C₃=empirically derived constants, and

$$Δ t = {t}_{x} - {t}_{i} .$$

Generally, 570 follows 560 (e.g., in response to the same).

At 580, the method 500 includes presenting the estimate remaining time at a user interface of the oven appliance (e.g., automatically or in response to 570). In some such embodiments, the presentation is provided as a countdown or “time to completion.” In other embodiments, the presentation is provided as a future clock time or “time at which the food item is ready.” Nonetheless, any suitable image or representation may be provided. For instance, at the user interface of the oven appliance, the estimated remaining may be shown, projected, or otherwise displayed (e.g., as would be understood). Thus, a user may have a clear view or understanding of the anticipated time needed in order for the food item to reach the desired state or target temperature. Subsequently (e.g., if the target temperature has not been reached or the cooking operation has not otherwise been halted), the method 500 may proceed to 590.

At 590, the method 500 includes setting new values for Tᵢ and tᵢ. In other words, the previously recorded values may be discarded and replaced with a new value recorded (e.g., temporarily) in that place. Specifically, the previous Tᵢ (e.g., Tᵢ₀) may be replaced with the previous Tₓ (e.g., Tₓ₀) (e.g., as used in the immediately preceding calculations or occurrence of the described steps). Similarly, the previous tᵢ (e.g., tᵢ₀) may be replaced with the previous tₓ (e.g., tₓ₀) (e.g., as used in the immediately preceding calculations or occurrence of the described steps). Subsequently (e.g., if the target temperature has not been reached or the cooking operation has not otherwise been halted), the method 500 may return to 530 such that new Tₓ and tₓ values (e.g., Tₓ₁ and tₓ₁) may be detected and recorded, and such that various subsequent steps may be repeated, as would be understood in light of the present disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance comprising:
a cabinet defining a cooking chamber;
a heat source disposed within the cooking chamber;
a temperature sensor in thermal communication with the cooking chamber to detect temperature at a food item therein;
a user interface comprising a display attached to the cabinet; and
a controller in operable communication with the temperature sensor, the controller being configured to direct a monitoring operation comprising
measuring a first temperature of a food item within the cooking chamber of the oven appliance,
determining elapse of a detection interval instance following detection of the first temperature,
measuring a second temperature of the food item following measuring the first temperature,
calculating a temperature delta between the second temperature and the first temperature,
determining the temperature delta is within a predetermined functional range,
determining a time delta of time between measuring the first temperature and measuring the second temperature,
estimating a remaining time of the food item based on the time delta in response to determining the temperature delta is within the predetermined functional range, and
presenting the estimated remaining time at the user interface of the oven appliance.

2. The oven appliance of claim 1, wherein the temperature is disposed within the cooking chamber of the oven appliance, wherein the first temperature is measured at the temperature sensor within the cooking chamber, and
wherein the second temperature is measured at the temperature sensor within the cooking chamber.

3. The oven appliance of claim 1, wherein determining the temperature delta is within the predetermined functional range comprises determining an absolute value of the temperature delta is less than or equal to an upper delta limit.

4. The oven appliance of claim 3, wherein determining the temperature delta is within the predetermined functional range comprises determining the temperature delta is greater than or equal to a lower delta limit following determining the absolute value of the temperature delta is less than the upper delta limit.

5. The oven appliance of claim 4, wherein the lower delta limit is less than or equal to 10° Fahrenheit.

6. The oven appliance of claim 1, wherein the monitoring operation further comprises
determining elapse of a second detection interval instance following detection of the second temperature,
measuring a third temperature of the food item in response to elapse of the second detection interval instance,
calculating a second temperature delta between the third temperature and the second temperature,
determining an absolute value of the second temperature delta is greater than an upper delta limit, and
maintaining the estimated remaining time in response to determining the absolute value of the second temperature delta is greater than or equal to the upper delta limit.

7. The oven appliance of claim 6, wherein the monitoring operation further comprises
determining elapse of a third detection interval instance following detection of the second temperature,
measuring a fourth temperature of the food item in response to elapse of the third detection interval instance,
calculating a third temperature delta between the fourth temperature and the third temperature,
determining the third temperature delta is within the predetermined functional range,
determining a third time delta of time between measuring the third temperature and measuring the fourth temperature,
updating the estimated remaining time of the food item based on the third time delta in response to determining the third temperature delta is within the predetermined functional range, and
presenting the updated estimated remaining time at the user interface of the oven appliance.

8. The oven appliance of claim 1, wherein the monitoring operation further comprises
determining elapse of a second detection interval instance following detection of the second temperature,
measuring a third temperature of the food item in response to elapse of the second detection interval instance,
calculating a second temperature delta between the third temperature and the second temperature,
determining the second temperature delta is less than a lower delta limit, and
maintaining the estimated remaining time in response to determining the second temperature delta is less than a lower delta limit.

9. The oven appliance of claim 8, wherein the monitoring operation further comprises
determining elapse of a third detection interval instance following detection of the second temperature,
measuring a fourth temperature of the food item in response to elapse of the third detection interval instance,
calculating a third temperature delta between the fourth temperature and the second temperature,
determining the third temperature delta is within the predetermined functional range,
determining a third time delta of time between measuring the second temperature and measuring the fourth temperature,
updating the estimated remaining time of the food item based on the third time delta in response to determining the third temperature delta is within the predetermined functional range, and
presenting the updated estimated time at the user interface of the oven appliance.

10. A method of operating an oven appliance, the method comprising:
measuring a first temperature of a food item within a cooking chamber of the oven appliance;
determining elapse of a detection interval instance following detection of the first temperature;
measuring a second temperature of the food item following measuring the first temperature;
calculating a temperature delta between the second temperature and the first temperature;
determining the temperature delta is within a predetermined functional range;
determining a time delta of time between measuring the first temperature and measuring the second temperature;
estimating a remaining time of the food item based on the time delta in response to determining the temperature delta is within the predetermined functional range; and
presenting the estimated remaining time at a user interface of the oven appliance.

11. The method of claim 10, wherein the first temperature is measured at a temperature sensor disposed within the cooking chamber of the oven appliance, and
wherein the second temperature is measured at the temperature sensor within the cooking chamber of the oven appliance.

12. The method of claim 10, wherein determining the temperature delta is within the predetermined functional range comprises determining an absolute value of the temperature delta is less than or equal to an upper delta limit.

13. The method of claim 12, wherein determining the temperature delta is within the predetermined functional range comprises determining the temperature delta is greater than or equal to a lower delta limit following determining the absolute value of the temperature delta is less than the upper delta limit.

14. The method of claim 13, wherein the lower delta limit is less than or equal to 10° Fahrenheit.

15. The method of claim 10, further comprising:
determining elapse of a second detection interval instance following detection of the second temperature;
measuring a third temperature of the food item in response to elapse of the second detection interval instance;
calculating a second temperature delta between the third temperature and the second temperature;
determining an absolute value of the second temperature delta is greater than an upper delta limit; and
maintaining the estimated remaining time in response to determining the absolute value of the second temperature delta is greater than or equal to the upper delta limit.

16. The method of claim 15, further comprising:
determining elapse of a third detection interval instance following detection of the second temperature;
measuring a fourth temperature of the food item in response to elapse of the third detection interval instance;
calculating a third temperature delta between the fourth temperature and the third temperature;
determining the third temperature delta is within the predetermined functional range;
determining a third time delta of time between measuring the third temperature and measuring the fourth temperature;
updating the estimated remaining time of the food item based on the third time delta in response to determining the third temperature delta is within the predetermined functional range; and
presenting the updated estimated time at the user interface of the oven appliance.

17. The method of claim 10, further comprising:
determining elapse of a second detection interval instance following detection of the second temperature;
measuring a third temperature of the food item in response to elapse of the second detection interval instance;
calculating a second temperature delta between the third temperature and the second temperature;
determining the second temperature delta is less than a lower delta limit; and
maintaining the estimated remaining time in response to determining the second temperature delta is less than a lower delta limit.

18. The method of claim 17, further comprising:
determining elapse of a third detection interval instance following detection of the second temperature;
measuring a fourth temperature of the food item in response to elapse of the third detection interval instance;
calculating a third temperature delta between the fourth temperature and the second temperature;
determining the third temperature delta is within the predetermined functional range;
determining a third time delta of time between measuring the second temperature and measuring the fourth temperature;
updating the estimated remaining time of the food item based on the third time delta in response to determining the third temperature delta is within the predetermined functional range; and
presenting the updated estimated time at the user interface of the oven appliance.
